(19) United States
(12) Patent Application Publication
(10) Pub. No.: US 2012/0185270 A1
(43) Pub. Date: Jul. 19, 2012

(54) APPARATUS AND METHOD FOR PROCESSING PRIOR AUTHORIZATIONS FOR PRESCRIPTION DRUGS

(75) Inventors: Matthew A. Scantland, Upper Arlington, OH (US); Scott Carson Ziegler, Columbus, OH (US); David Edward Bowen, Columbus, OH (US); Samuel M. Rajan, Hudson, OH (US); Bruce Wayne Nation, Gahanna, OH (US)

(73) Assignee: COVERMYMEDS, LLC., Columbus, OH (US)

(21) Appl. No.: 13/413,231

(22) Filed: Mar. 6, 2012

Related U.S. Application Data
(63) Continuation of application No. 13/030,972, filed on Feb. 18, 2011.
(60) Provisional application No. 61/306,272, filed on Feb. 19, 2010.

(51) Int. Cl. G06Q 40/08; G06Q 50/22

(52) U.S. Cl. 705/2

(57) ABSTRACT

An apparatus, a method, and a computer program product are provided. The apparatus includes at least one memory including computer program code, and at least one processor. The at least one memory and the computer program code are configured to, with the at least one processor, cause the apparatus at least to receive a request to generate a prior authorization form for a prescription drug, select the prior authorization form from a plurality of prior authorization forms based on the request, and transmit the selected prior authorization form to a user so that the user can complete and submit the prior authorization form to the health plan and receive a determination on the request. The prior authorization form is selected based on at least one of a user search result and a standardized transaction.

### CROSS REFERENCE TO RELATED APPLICATION

This application is a continuation of U.S. patent application Ser. No. 13/030,972 which claims priority under 35 U.S.C. §119(e) of U.S. Provisional Patent Application Ser. No. 61/306,272, filed on Feb. 19, 2010. The subject matter of these earlier filed application is hereby incorporated by reference.

### BACKGROUND

1. Field

Embodiments of the invention relate to the processing of prior authorizations for prescription drugs. More specifically, certain embodiments of the invention are directed to an apparatus, a method, and a computer program product for processing prior authorizations for prescription drugs.

2. Description of the Related Art

Prior authorization is the requirement for pre-approval for coverage of a prescription drug by a health insurance provider. Prior authorization may be implemented, for example, in the form of a formulary (i.e., a list of drugs that are covered by a health insurance plan). Formulary restrictions, which further restrict the list of drugs, may include, for example, a limit on a quantity of the prescription drug, a limit on the duration that the prescription drug can be used by a patient, and pre-set, specific clinical or drug use requirements for the prescription drug. Prior authorization requirements are typically published by health insurance providers for each of their respective health care plans, but may usually, however, also be enforced by denying an insurance claim when coverage restriction criteria for a requested prescription drug is not met. The denial of coverage of the requested prescription drug may be referred to as a “reject.”

Upon receiving a rejection for coverage of a prescription drug, most health insurance providers require that a request be completed and submitted to the health insurance provider. The request is typically submitted by a health care provider, such as a physician. The request may be presented in the form of, for example, a coverage determination or prior authorization form.

Coverage determination may include a printable document with administrative, demographic, and clinical questions that the health care provider must complete, and fax to the health insurance provider. Finding the correct form to use and completing each of the required fields in the form may be a challenge for many health care providers. Upon submission of the form to the health insurance provider, the coverage determination will be reviewed and a coverage decision will be rendered. The request may be denied, approved, cancelled, or the health insurance provider may ask for additional information.

Denial of prescription drug coverage results in frustrations for both the health care provider and the patient, which could lead to the patient not being treated with the prescribed medication, potentially causing more severe medical problems for the patient. Studies have shown that approximately only 30 percent of patients actually receive the prescription drug prescribed for their medical condition, after an initial claim rejection. Approximately 30 percent received a different drug than the prescription drug prescribed for their medical condition. Furthermore, approximately 40 percent of patients did not receive any treatment within six months of having their claim rejected.

### SUMMARY

In accordance with an embodiment of the invention, there is provided at least one memory including computer program code, and at least one processor. The at least one memory and the computer program code are configured to, with the at least one processor, cause the apparatus at least to receive a request to generate a prior authorization form for a prescription drug. The at least one memory and the computer program code are also configured to, with the at least one processor, cause the apparatus at least to select the prior authorization form from a plurality of prior authorization forms based on the request, and transmit the selected prior authorization form to a user so that the user can complete the prior authorization form. The prior authorization form is selected based on at least one of a user search result and a standardized transaction.

In accordance with another embodiment of the invention, there is provided a method, which includes receiving a request to generate a prior authorization form for a prescription drug, and selecting the prior authorization form from a plurality of prior authorization forms based on the request. The prior authorization form is selected based on at least one of a user search result and a standardized transaction. The method further includes transmitting the selected prior authorization form to a user so that the user can complete the prior authorization form.

In accordance with another embodiment of the invention, there is provided a computer program product embodied on a non-transitory computer readable storage medium. The computer program product is encoded with instructions to control a processor to perform a process. The processing includes receiving a request to generate a prior authorization form for a prescription drug, and selecting the prior authorization form from a plurality of prior authorization forms based on the request. The prior authorization form is selected based on at least one of a user search result and a standardized transaction. The process further includes transmitting the selected prior authorization form to a user so that the user can complete the prior authorization form.

### BRIEF DESCRIPTION OF DRAWINGS

Further aspects, details, advantages and modifications of the invention will become apparent from the following detailed description of the embodiments, which is to be taken in conjunction with the accompanying drawings, in which:

FIG. 1 shows a process for processing a prior authorization for a prescription drug.

FIG. 2 shows an apparatus, in accordance with an embodiment of the invention.

FIG. 3 shows form encoding features that can be performed by the apparatus, as shown in FIG. 2, in accordance with an embodiment of the invention.

FIG. 4 shows a transactional model using form encodings, in accordance with an embodiment of the invention.

FIG. 5 shows a method for processing a prior authorization for a prescription drug, in accordance with an embodiment of the invention.

FIGS. 6 and 7 show flow diagrams of the method, as shown in FIG. 5, in accordance with an embodiment of the invention.

FIG. 8 shows a flow diagram of a method for determining the status of a prior authorization on the provider's behalf, in accordance with an embodiment of the invention.

FIG. 9a shows a schematic of a request/response prior authorization workflow, in accordance with an embodiment of the invention.

FIG. 9b shows a schematic for supplementing a request/response transaction to provide directory services and a visual or paper-based “compatibility layer” between parties that do not support the requested transaction type, in accordance with an embodiment of the invention.

### DETAILED DESCRIPTION

It will be readily understood that the components of the invention, as generally described and illustrated in the figures herein, may be arranged and designed in a wide variety of different configurations. Thus, the following detailed description of the embodiments of an apparatus, a method, and a computer program product, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” or other similar language, throughout this specification do not necessarily all refer to the same group of embodiments, and the described features, structures, or characteristics may be combined in any suitable manner in one or more embodiments.

If desired, the different functions discussed below may be performed in a different order and/or concurrently with each other. Furthermore, if desired, one or more of the above-described functions may be optional or may be combined. As such, the foregoing description should be considered as merely illustrative of the principles, teachings and embodiments of this invention, and not in limitation thereof.

Some embodiments of the invention combine hardware and software components to create an apparatus, a method, and a computer program product for processing a prior authorization for a prescription drug. In particular, certain embodiments of the invention provide for processing a prior authorization for a prescription drug that permits a health care provider, a pharmacy, a patient, and their staff, to complete and submit the prior authorization form for the prescription drug using a graphical user interface, as will be discussed in more detail below.

In accordance with an embodiment of the invention, there are “client” applications (e.g., a user interface of which a graphical user interface and a third party widget are examples) and a server application, such that multiple clients can interact with server data through an application programming interface (API) that uses an application-agnostic “wire format,” such as an extensible markup language-remote procedure calling protocol (XML-RPC), a simple object access protocol (SOAP), or representational state transfer (REST). Therefore, an embodiment of the invention allows third parties to implement “client” applications that interact with an apparatus (e.g., a server), as will be discussed below in more detail, thereby creating a distributed computing environment that can leverage existing clinical systems such as pharmacy dispensing systems or electronic health records as API clients.

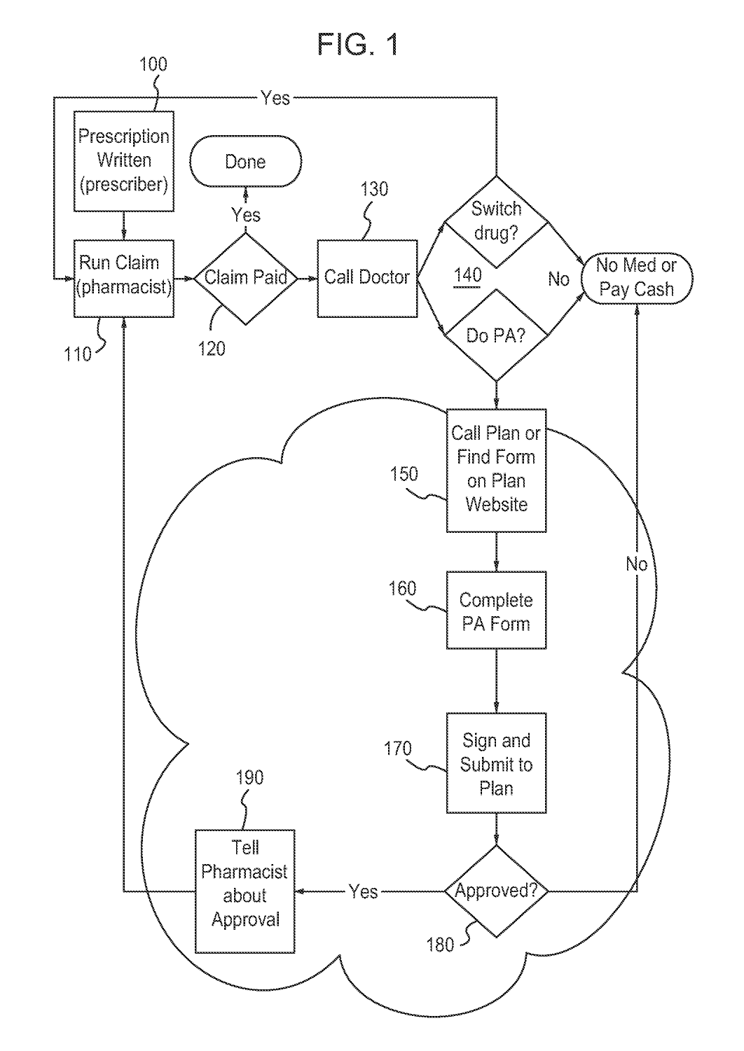

FIG. 1 shows a process for processing a prior authorization for a prescription drug. In step 100, a prescription is written by a health care provider for treating a medical condition of a patient. The patient takes the prescription to a pharmacy to have the drug prescription filled or it is transmitted to the pharmacy electronically. The pharmacy files a prescription drug claim, typically electronically, with a health insurance provider (step 110). The health insurance provider either approves, denies, cancels, or requests additional information from the pharmacy to further process the request (step 120). If the prescription drug claim request is approved by the health insurance provider, the patient receives the prescription drug. In some cases, the patient may be required to provide a co-payment based on the provisions in his health insurance plan.

If the prescription drug claim request is denied or cancelled, the pharmacy may call the health care provider to request the health care provider to prescribe a different drug or request that the health care provider complete a prior authorization form (step 130). If either of these requests are denied by the health care provider, then the patient may be forced to pay the entire amount of the prescription drug out of his pocket, or not receive any drug for his medical condition (step 140).

If the health care provider decides to complete the prior authorization form, the health care provider may have to contact the health insurance provider to determine the appropriate form to complete, or the health care provider may have to find the appropriate prior authorization form from the health insurance provider's website (step 150). Either option may require a significant amount of time and effort by the health care provider because the health care provide may have a difficult time locating a representative of the health insurance provider to assist the health care provider with locating the appropriate form. Furthermore, the health care provider may have a difficult time locating the appropriate form on the health insurance provider's website.

Once the appropriate prior authorization form is found, the health care provider must expend time and effort to complete the required fields on the prior authorization form (step 160). Knowing which fields to complete may be difficult. Once the prior authorization form is completed, the health care provider submits the form and waits for a response from the health insurance provider (step 170).

As previously described, if the health insurance provider denies or cancels the prior authorization form, then the patient may be forced to pay the entire amount of the prescription drug out of his pocket, or not receive any drug for his medical condition (step 180).

If the health insurance provider approves the prior authorization form, then the health care provider must contact the pharmacy to inform the pharmacy that the prescription drug has been approved (step 190). Upon receiving notice of the prescription drug approval, the pharmacy resubmits its prescription drug claim request, and waits for final approval from the health insurance provider (step 110).

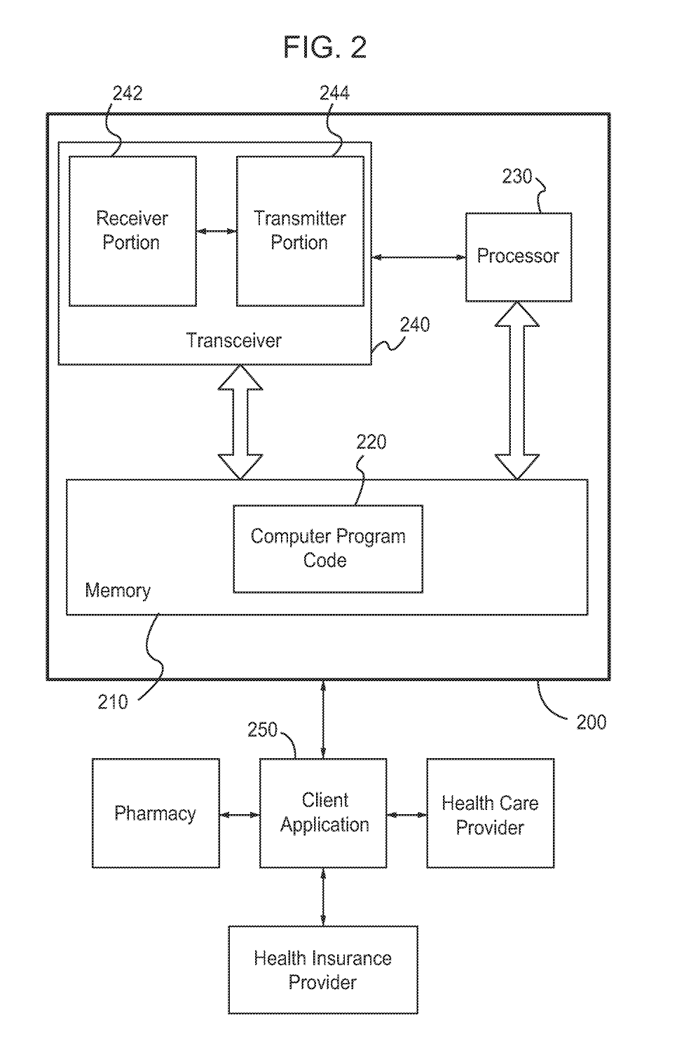

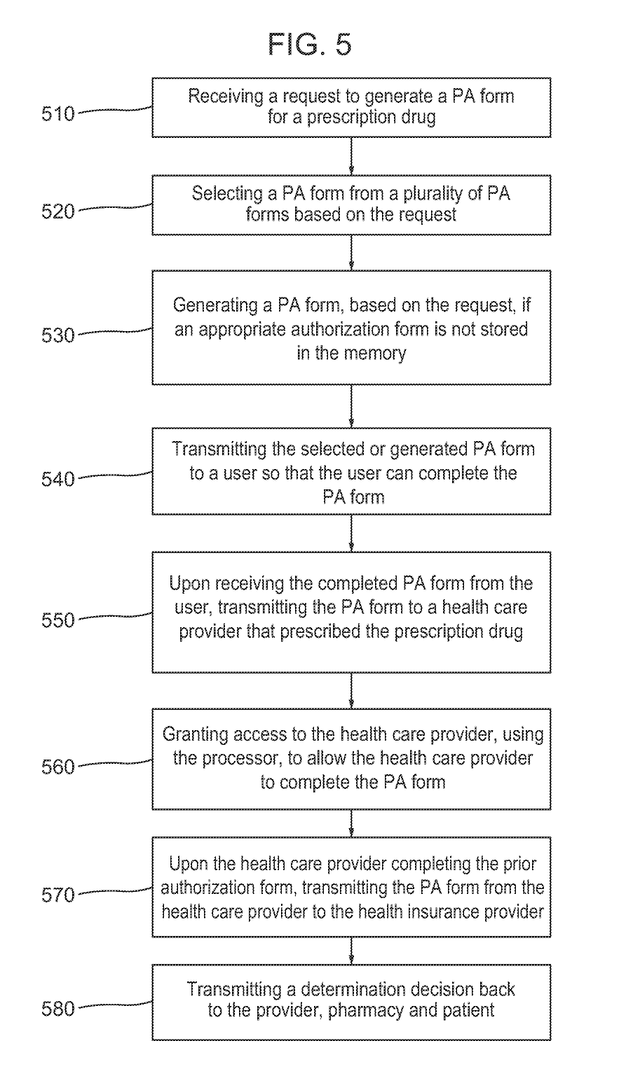

FIG. 2 shows an apparatus in accordance with an embodiment of the invention. The apparatus 200 can include, for example, a server or other network-enabled node. The apparatus 200 can include a memory 210 including computer program code 220. The computer program code 220 can be embodied on a computer readable non-transitory medium. The apparatus 200 can also include a processor 230 for processing information and executing instructions or operations. The memory 210 can be coupled to the processor 230 for storing information and instructions to be executed by the processor 230. The computer program code 220 can be encoded with instructions to control the processor 230 to perform a process, such as the methods shown in FIGS. 5-7, as will be discussed below in more detail.

While a single memory 210 and a single processor 230 are shown in FIG. 2, multiple memory and multiple processors can be utilized according to other embodiments.

The apparatus 200 can be configured to communicate, using a transceiver 240 having a receiver portion 242 and a transmitter portion 244, with a health insurance provider, health care provider and a pharmacy. The receiver portion 242 can be configured to receive a rejection from a health insurance provider for a prescription drug claim request. The receiver portion 242 can further be configured to receive a request from a user via a graphical user interface 250 to generate a prior authorization form. The user may include at least one of a pharmacy, a health care provider, and a patient. The request can include information, including, for example, a prescription claim, a clinical summary record, a health care document format such as HL7 or CCR, or user-entered data such as identifiers to describe the insurance provider and the prescription drug for which the request is being made. The graphical user interface 250 can be embedded as a widget or icon, for example, in a third party website (i.e., the health insurance provider's website, or a social media site, such as Facebook, MySpace, blog, etc.), facilitating the user's access to the apparatus.

The processor 230 can be configured to select a prior authorization form, based on the request, from a plurality of authorization forms stored in the memory 210. The processor 230 can further be configured to generate a prior authorization form or electronic version thereof, based on the request, if an appropriate authorization form is not stored in the memory. The transmitter portion 244 can be configured to transmit the selected or generated prior authorization form to the user. Upon receiving the completed prior authorization form from the user, the transmitter portion 244 can further be configured to transmit the selected or generated prior authorization form to the health care provider or pharmacy. Access to the prior authorization form can be granted, using the processor 230, to a plurality of users. A record of users that should have access to the prior authorization form, and their accounts, can be stored in the memory 210. By default, the creator of the prior authorization form can be entered into the access log. When the prior authorization form is shared with a health care provider, that health care provider can be added to the access log to track shared activity.

Upon transmitting the prior authorization form, the processor 230 can be configured to issue a notice to the health care provider, for example, an e-mail, a facsimile, or a phone call, which informs the health care provider that he can access the prior authorization form using the graphical user interface 250 or another client application. This notification can include, an access address, for example a URL, together with a “shared secret” for example, the patient's last name, and the patient's date of birth, which together can constitute a “shared secret” so that access to a prior authorization may be provisioned securely at an otherwise “public” interface, thus enabling a provider that is not a current invention user to use the system. After access is granted to the health care provider by the processor 230, the processor 230 can be configured to allow the health care provider to complete the prior authorization form. The health care provider can also be requested to create a user account, if for example they accessed the prior authorization through a shared secret. Upon completing the prior authorization form, the transmitter portion 244 can be configured to transmit the form from the health care provider to the health insurance provider, whereby the health insurance provider can determine whether to approve, deny, cancel, or request additional information for the prior authorization form. Upon determining the prior authorization, the health care insurance provider may update the prior authorization status through an API request, a batch file, or an out-of-band communication such as a fax or postal mail directly to the parties involved in the transaction.

The memory 210 can be configured to store a plurality of prior authorization forms for the user, enabling a workflow system to be constructed in a graphical user interface, or through API methods, which may be provided to third-party client applications. This memory also enables re-submission of prior authorization forms, for example after a denial decision (an “appeal”) or after an “approved-through” time expires.

In another embodiment of the invention, as further shown in FIG. 2, a user, such as the pharmacy, the health care provider, or a patient, can access the apparatus 200 via the graphical user interface 250. The receiver portion 242 can be configured to receive information, such as a login identification and password, both of which are created when the user creates his account, through the graphical user interface 250. The receiver portion 242 can further be configured to receive information related to a selection by the user for creating a new prior authorization form. The information can include input search terms, for example, the state in which the request is being made, the patient's health insurance provider, and the prescription drug for which the request is being made for prior authorization. The processor 230 can be configured to select a prior authorization form, based on the information, from a plurality of authorization forms stored in the memory 210. The processor 230 can further be configured to generate the plurality of authorization forms using information received from a health care transaction, or other related meta-data received from user input. The transmitter portion 244 can further be configured to transmit the selected prior authorization form to the user. The processor 230 can be configured to fill in pre-populated demographic information in the prior authorization form based on the information provided by the user. The processor 230 can further be configured to modify the prior authorization form in real-time using at least one of a user input, the user search result, and the existing pharmacy transaction.

If the user is the health care provider, i.e., the user is prescribing the requested prescription drug, the transmitter portion 244 can be configured to transmit the prior authorization form, upon the health care provider completing the remaining required fields on the prior authorization form and electronically signing the prior authorization form, to the health insurance provider.

If the user is not the health care provider, i.e., the user is the pharmacy, the transmitter portion 244 can be configured to transmit the prior authorization form to the health care provider prescribing the prescription drug, as previously described. If sufficient data is entered by the pharmacy through an API request (for example, a request that includes a health care transaction such as the rejected claim), this transmission to the health care provider can be automated for the pharmacy, enabling the transmission without a requirement that the pharmacy access a graphical user interface.

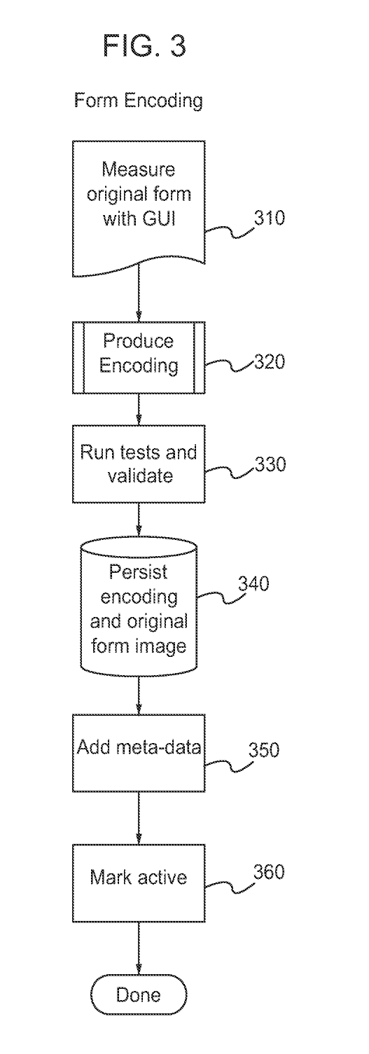

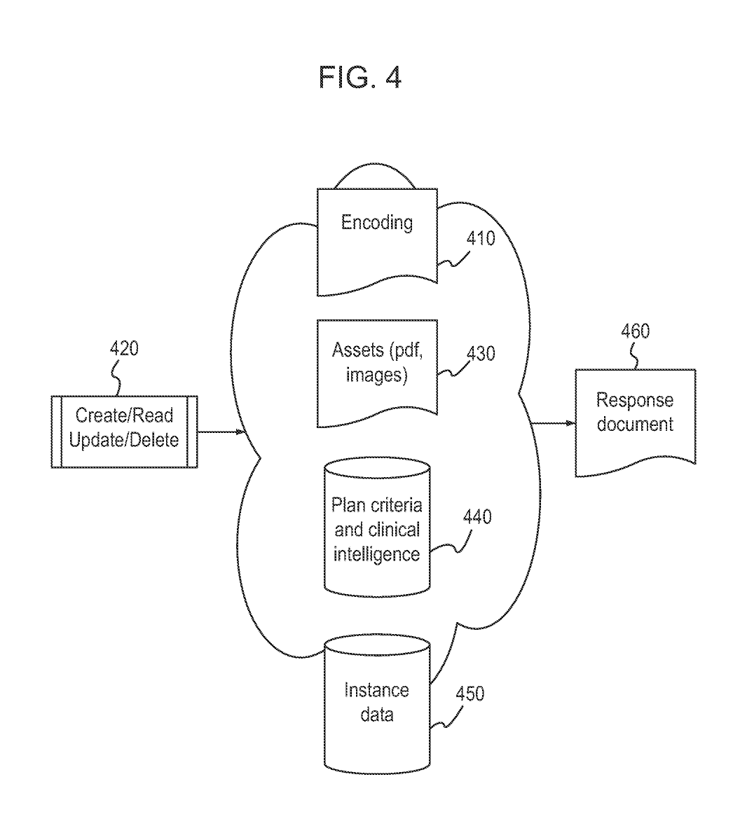

In accordance with another embodiment of the invention, the apparatus 200 can be configured to provide form encoding using domain-specific markup language that describes prior authorizations in a machine readable format, as shown in FIGS. 3 and 4, as will be described in more detail below. In particular, FIG. 3 shows form encoding features that can be performed by the apparatus, as shown in FIG. 2, in accordance with an embodiment of the invention. FIG. 4 shows a transactional model using form encodings, in accordance with an embodiment of the invention.

As shown in FIG. 3, the apparatus 200 can be configured to measure an original prior authorization form 310 using the graphical user interface 250. The apparatus 200 can further be configured to produce encoding 320, run tests and validate the encoding 330, generate further encoding and an original prior authorization form image 340, add meta-data 350, and mark the prior authorization form encoding as active 360. As shown in FIG. 4, the apparatus can further be configured to perform form encoding 410, which can include creating, reading, updating, and deleting 420, for example, encoding assets (e.g., pdfs and images) 430, plan criteria and clinical intelligence 440, and instance data 450. As a result, a response or resulting prior authorization form can be generated as an output form for a user to fill out, or as a response object to an API request 460.

In accordance with certain embodiments of the invention, the processor 230 can be configured to encode the prior authorization form in a machine readable format, such that arbitrary input mechanisms and arbitrary output formats or mechanisms can be constructed to, for example, output a pre-populated prior authorization form using the health insurance provider's original document.

For example, the machine readable format may include a markup language representation of the prior authorization that can be used to describe any prior authorization form. The markup language can be used to provide both input and output representations of the prior authorization form, for use in a graphical user interface or as a response object to an API request. The input and output representations can be generated in any arbitrary format, including, for example, a web-form, a native desktop application, a mobile device application, or an interactive voice application. Output formats can include, for example, a visual PDF representation as well as machine-readable data representations, including, for example, extensible markup language (XML), JavaScript object notation (JSON), or flat text. The markup language can be translated through custom interpretive code or translation languages, for example, XML path language (XPath) or extensible stylesheet language transformations (XSLT). The output formats can also include standard health care transactions such as a pharmacy claim, an EDI transaction such as the 278, or a prior authorization transaction.

The markup language may be commercially valuable because it allows for the encoding of a large number of prior authorization forms for machine use with relatively low skilled labor and automation and prevents duplicate data entry by the provider, saving the user time and effort. The markup language can be used to provide nationwide standardization of e-prescribing and electronic health record systems. The markup language can also be configured to interoperate with existing standards, such as the national council for prescription drug programs (NCPDP) prior authorization standards.

The markup language can be configured to define semantic content of any known extant prior authorization form, define flow-control logic (i.e., if A, then complete B, else complete C), capture metadata about the prior authorization form that can be used to optimize search results for the form, and define original input/output formats so that data captured by arbitrary input mechanisms can be used to populate the original prior authorization form. The markup language can further be configured to, for example, encapsulate the form encoding in a serialized object representation (i.e., implemented with XML, JSON, a human-readable data serialization format (e.g., YAML), or a custom format), provide security characteristics, reduce errors, or form encodings can be used in combination with each other to produce new instances of the form representing additional criteria or questions that facilitate the completion of the prior authorization form, or to simplify management of prior authorization data using a templating system.

The apparatus 200 can further be configured to allow a distributed network of client applications to connect to a distributed network of server applications for parsing prior authorization input and producing formatted output, for example, into a prior authorization form. Furthermore, the apparatus 200 can be configured to provision access to various users. For example, the apparatus 200 can be configured to grant access to a user, for example, a pharmacy, for initiating the prior authorization process, and to another user, for example, a health care provider, for completing the prior authorization form. Furthermore, the apparatus 200 allows a user, for example, a patient, to electronically sign the prior authorization form, and to submit the form to the health insurance provider. The apparatus 200 grants access to the pharmacy, the health care provider, and the patient, or any third party user by presenting a set of challenge questions to verify that the requesting user is authorized to view the prior authorization form and any associated information. For example, the requesting user may be asked to provide a patient's date of birth before being able to access the health information of the patient.

The apparatus 200 also allows existing paper-based prior authorization forms, encoding using the technology described in this invention, to interoperate with health care data standards and arbitrary and non-standard formats for generating the prior authorization form. Further, the apparatus 200 provides the pharmacy with the ability to utilize existing pharmacy industry transactions for starting and completing the prior authorization process using a prescription drug claim, permitting the pharmacy to submit prior authorizations without a requirement for additional hardware or software integration.

The apparatus 200 can further be configured to present drug coverage criteria, additional questions, and safety and clinical information in-line with plan-provided prior authorization form content to educate health care providers to ensure that coverage criteria in the prior authorization form is completed so that the form can be evaluated by the health insurance provider. The apparatus 200 can further be configured to use existing pharmacy claim transactions to identify whether prior authorizations were approved or denied. Using this historical data, the apparatus 200 can determine which claim stream method to utilize for processing future prior authorization forms.

The apparatus 200 can provide both deterministic form selection or a probability-based-search to identify the appropriate prior authorization form. Probability-based search can include full text searches across multiple search substrates, which allows the processor 230 to generate the appropriate prior authorization form based on these searches. The apparatus 200 can also be configured to incorporate prescription claims, prior search history and other user input, including input and search history from other users for which the processor 230 generates the appropriate prior authorization form. The apparatus 200 may be a machine-learning system that incorporates usage data and formulary data for improving search results for prior authorization forms. Or, the apparatus may be an “expert system” for example, the apparatus 200 may allow users to tag prior authorization search results so that they create their own search substrate to use for subsequent retrieval of the same or similar search results, or the system may use aliases, synonyms, and phonetic algorithms to form a thesaurus that helps to anticipate and retrieve search results based on user search terms.

The apparatus 200 can be coupled with a co-pay assistance program (i.e., capturing data and initiating the process because the patient wants co-pay assistance) for increasing utilization of the prior authorization system. The co-pay assistance program may use coupons, automatic offset, or a third-party payer scheme to subsidize the patient's co-pay amount.

The apparatus 200 can be coupled with a “starter fill” or sampling program (i.e., capturing data and initiating the process because the patient wants a starter fill) for increasing utilization of the prior authorization system. The starter fill program can be administered at the prescribing physicians office or at the pharmacy. One configuration of this system which may be valuable is only providing the sample or starter fill after a claim rejection, or after a benefit check reveals that prior authorization may be required.

The processor 230 can be further configured to notify the patient, using e-mail messages, facsimiles, text messages (e.g., SMS), or postal mail when the prescription drug has been approved and filled, and/or it may be configured to send a similar message to the patient to encourage them to have their physician complete the patient's prior authorization forms. Similarly, the system may generate provider-specific patient handouts to encourage form completion, and may generate automated follow-up tasks to encourage prior authorization completion.

The apparatus 200 may include an automated voice response system for allowing a health care provider or pharmacy to request prior authorization forms. It may use an automated voice response system to read the prior authorization form content and allow the provider or pharmacy to answer questions and generate a completed prior authorization form for submission to the health plan.

The apparatus 200 further provides video and other training mediums through the graphical user interface 250 to present content based on the state of a users involvement with the system such that “blank slates” are avoided and new users of the system are quickly educated in the systems use.

The apparatus 200 can further use feedback from the user to determine or infer the disposition of the prior authorization (whether approved, denied, cancelled, in process, or similar).

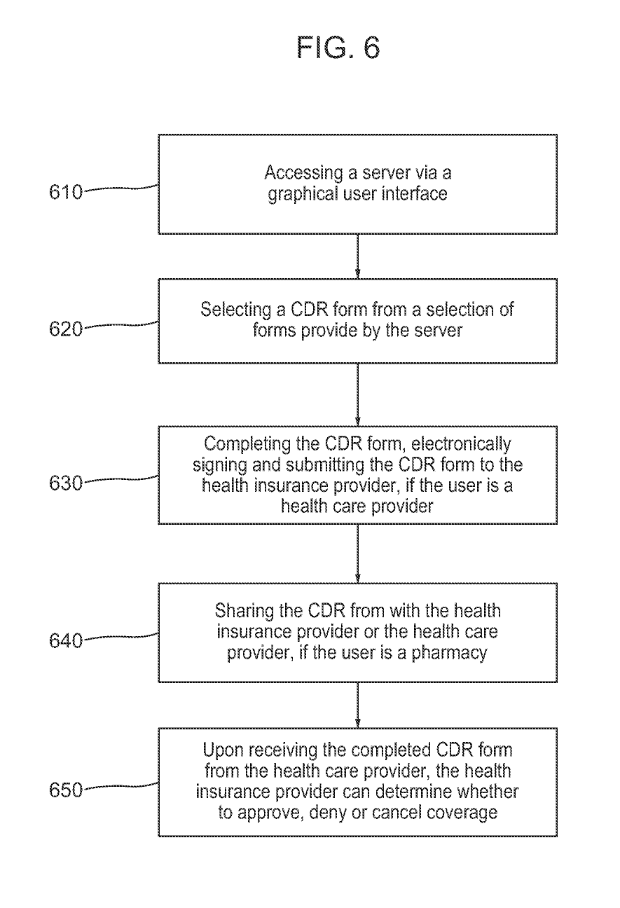

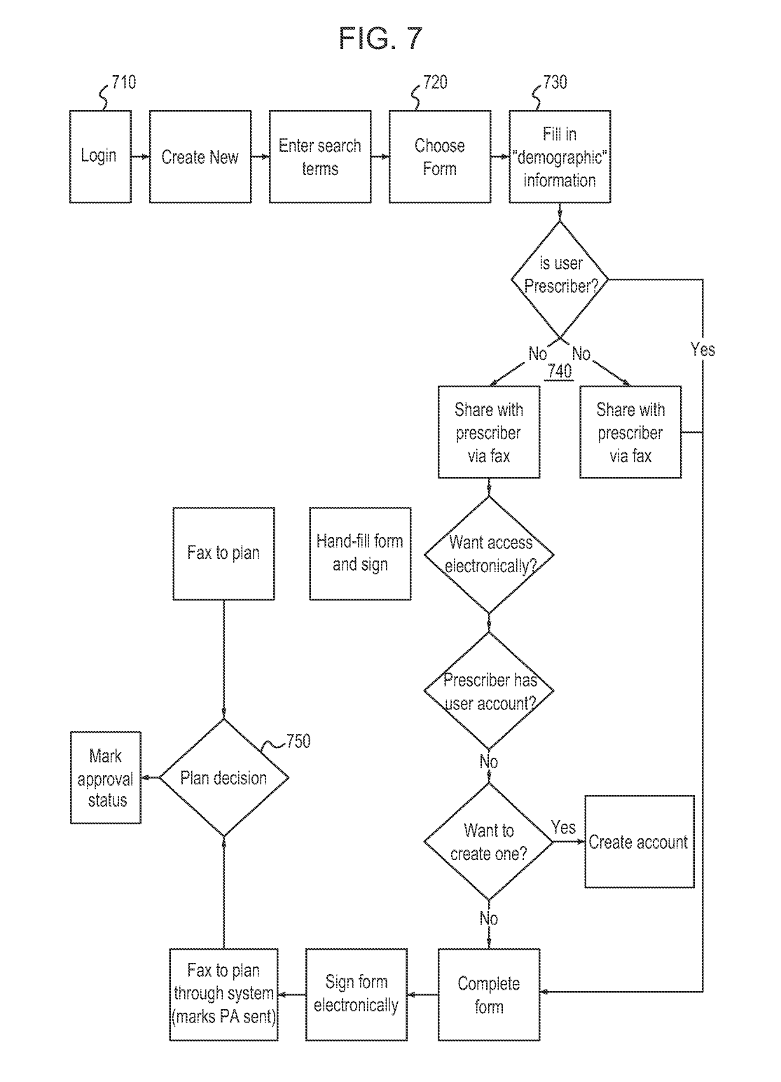

FIG. 5 shows a method for processing a prior authorization for a prescription drug, in accordance with an embodiment of the invention. FIGS. 6 and 7 show flow diagrams of the method, as shown in FIG. 5, in accordance with an embodiment of the invention. The method, as shown in FIG. 5, includes receiving a request, from a user via a graphical user interface, to generate a prior authorization form (step 510). The user may include at least one of a pharmacy, a health care provider, and a patient. The request can include information, such as the state in which the request is being made, the patient's health insurance provider, and the prescription drug for which the request is being made for prior authorization. The graphical user interface can be embedded as a widget or icon, for example, in a third party website (i.e., the health insurance provider's website, or a social media site, such as Facebook, MySpace, blog, etc.), facilitating the user's access to the apparatus.

The method further includes selecting a prior authorization form, based on the request, from a plurality of authorization forms stored in memory (step 520). The method further includes generating a prior authorization form, based on the request, if an appropriate authorization form is not stored in the memory (step 530). The method further includes transmitting the selected or generated prior authorization form to the user, so that the user can modify the prior authorization form (step 540). Further, the method includes, upon receiving the completed prior authorization form from the user, transmitting the prior authorization form to a health care provider that prescribed the prescription drug through an encrypted scheme, for example, a REST-ful URL addressing scheme, that allows an unique prior authorization form to be accessible at a same URL (step 550). Access to the prior authorization form can be granted, using the processor, to a plurality of users. A record of users that may have access to the prior authorization form, and their accounts, can be stored in the memory. By default, the creator of the prior authorization form can be entered into the access log. When the prior authorization form is shared with a health care provider, that health care provider can be added to the access log to track shared activity.

The step of transmitting can further include issuing a notice to the health care provider, for example, an e-mail, a facsimile, or a phone call, which informs the health care provider that he can access the prior authorization form using the graphical user interface. This notification can include, for example, the following information: the URL, which uniquely addresses the prior authorization form, the patient's last name, and the patient's date of birth. The method can further include granting access to the health care provider, using the processor, to allow the health care provider to complete the prior authorization form (step 560). The health care provider can also be requested to create a user account to access the graphical user interface. The method can further include, upon the health care provider completing the prior authorization form, transmitting the prior authorization form from the health care provider to the health insurance provider, whereby the health insurance provider can determine whether to approve, deny, cancel, or request additional information for the prior authorization form (step 570).

In another embodiment of the invention, upon receiving a rejection from the health insurance provider for a prescription drug claim request (i.e., receiving a bank routing number or a rejection code from the health insurance provider), a determination can be made to proceed with a coverage determination request (CDR). If it is determined that the CDR should be submitted, a pharmacy can access, using, for example, the graphical user interface, a server to identify the proper CDR form. The proper CDR form can be determined by identifying the state in which the request is being made, identifying the patient's health insurance provider, and identifying the prescription drug for which the request is being made for prior authorization.

Upon providing this information, the pharmacy can transmit the CDR form using the graphical user interface to the health care provider. The health care provider can access the server through the graphical user interface without the need for a user account. By transmitting the CDR form, using the graphical user interface of the server, the pharmacy can share the information with the health care provider through an encrypted scheme, for example, a REST-ful URL addressing scheme, that allows an unique CDR form to be accessible at the same URL. Access to the CDR form can be granted by a record of user accounts, stored in a memory of the server, that should have access to the CDR form. By default, the creator of the CDR form can be entered into the access log. When a CDR form is shared with a health care provider, that health care provider can be added to the access log to track shared activity.

Upon sharing the CDR form, the server can issue a notice, for example, a facsimile, an e-mail, a text message, or a phone call, to the health care provider that informs the health care provider that he can access the CDR form using the graphical user interface of the server. This notification can include the following information: the URL, which uniquely addresses the CDR form, the patient's last name, and the patient's date of birth. After access is granted to the health care provider, the server can be configured to allow the health care provider to complete the CDR form. The health care provider can also be requested to create a user account to access the graphical user interface of the server. Upon completing the CDR form, the health care provider can submit the form, using the graphical user interface of the server, to the health insurance provider.

Upon receiving the completed CDR form, the health insurance provider can make a determination of whether the patient's health care plan will cover the requested prescription drug. A notification of the health insurance provider's decision can be received by the pharmacy, the health care provider, and the patient using the graphical user interface of the server.

As shown in FIGS. 6 and 7, a user, such as a pharmacy or a health care provider, can access a server via a graphical user interface (steps 610/710). Accessing the server can include inputting a login identification and password, both of which are created when the user creates his account. The user can select to create a new CDR form. The user can input search terms, for example, the state in which the request is being made, the patient's health insurance provider, and the prescription drug for which the request is being made for prior authorization. Based on this information, the user selects a CDR form from a selection of forms provided by server, and fills in demographic information on the CDR form (steps 620/720).

If the user is a health care provider, i.e., the user is prescribing the requested prescription drug, then the health care provider can complete the remaining required fields on the CDR form, electronically sign the CDR form, and submit the CDR form to the health insurance provider using the graphical user interface of the server (steps 630/730).

If the user is not the health care provider, i.e., the user is a pharmacy, the user can share the CDR form, using the graphical user interface of the server, with the health care provider prescribing the prescription drug. In this case, the health care provider can complete and submit the CDR form as previously discussed (steps 640/740).

In the alternative, the pharmacy can share the CDR form with the health care provider prescribing the prescription drug via facsimile, whereby the health care provider can either create an account for accessing the graphical user interface of the server. As previously discussed, the health care provider can complete and submit the CDR form to the health insurance provider using the graphical user interface of the server.

Upon receiving the completed CDR form from the health care provider, the health insurance provider can determine whether to approve, deny, cancel, or request additional information for the CDR form (steps 650/750).

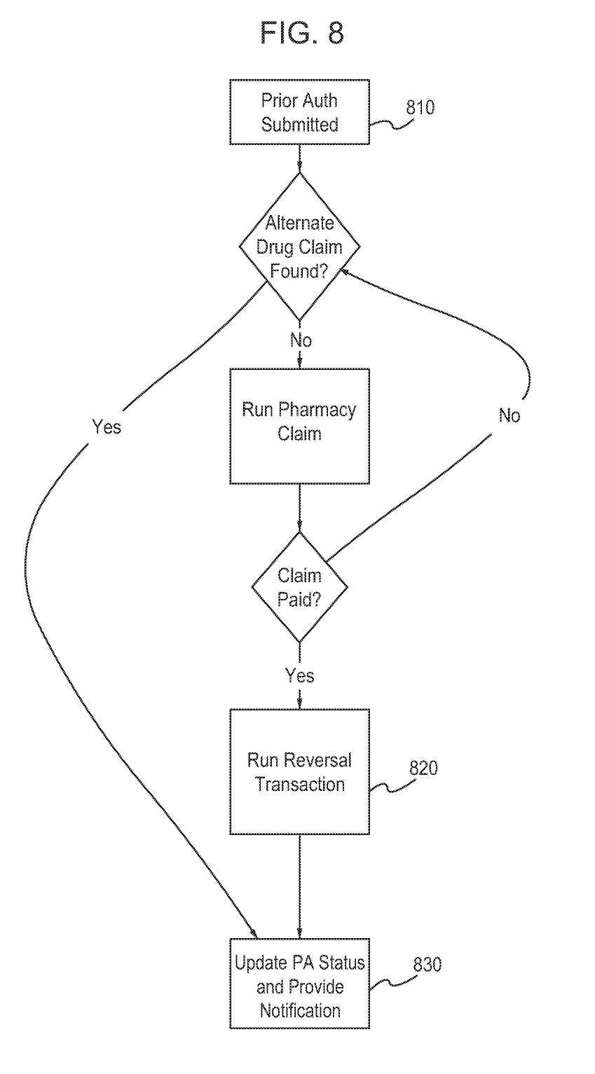

FIG. 8 shows a flow diagram of a method for determining the status of a prior authorization on the provider's behalf, in accordance with an embodiment of the invention. The method can determine when a prior authorization is approved by the health plan, and can subsequently be paid by the processor after a new claim is submitted by the pharmacy. Among other reasons, this is valuable because a health plan may fail to notify the pharmacy or health care provider that a prior authorization has been approved, since laws and regulations often only require notification to the patient. In an embodiment of the invention, the method provides for storage of certain data that allows a prescription claim to be reconstructed when a prior authorization is submitted through the system discussed above. After a submission of the prior authorization (step 810), this reconstructed claim can be assembled and submitted to the health plan on behalf of the pharmacy. If the claim is approved and paid, the claim may be reversed so that it does not create a receivable for the pharmacy (step 820). If the claim is approved and paid, it becomes known that the corresponding prior authorization has been submitted and approved (step 830).

The method shown in FIG. 8 also illustrates a process for using existing pharmacy claims data to identify if a prior authorization has been submitted and approved. This process is similar to the process discussed above, with the exception that existing claims data are used to identify if the drug for which the prior authorization was submitted has been resubmitted and paid. This process can also be used to determine if the patient was switched to a drug that is similar to the requested product but not identical, for example, if a generic drug has been substituted for a brand drug. This data is useful to notify the prescribing health care provider, who typically does not have access to the claim data, or to validate the usefulness of the invention for drug manufacturers.

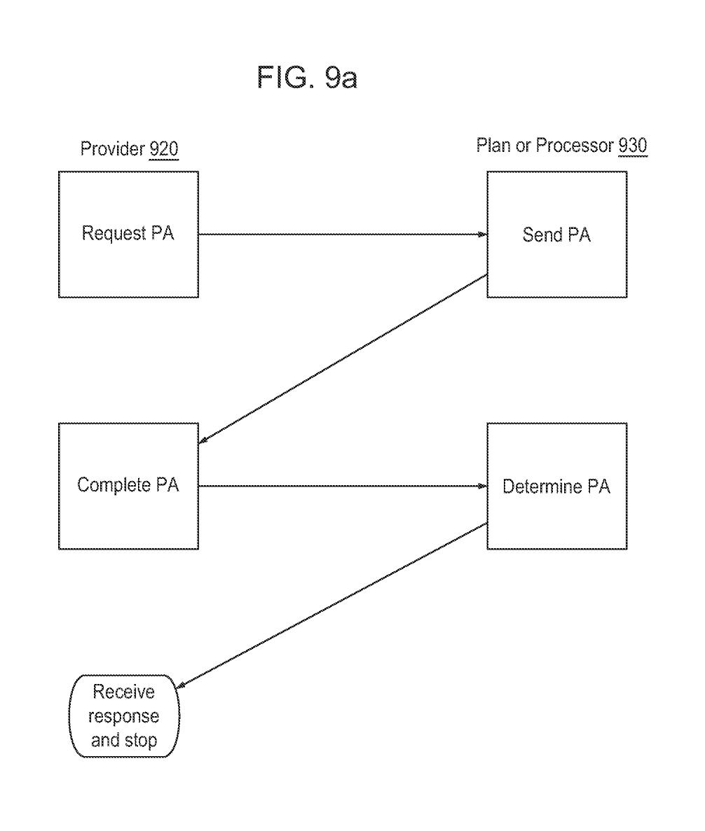

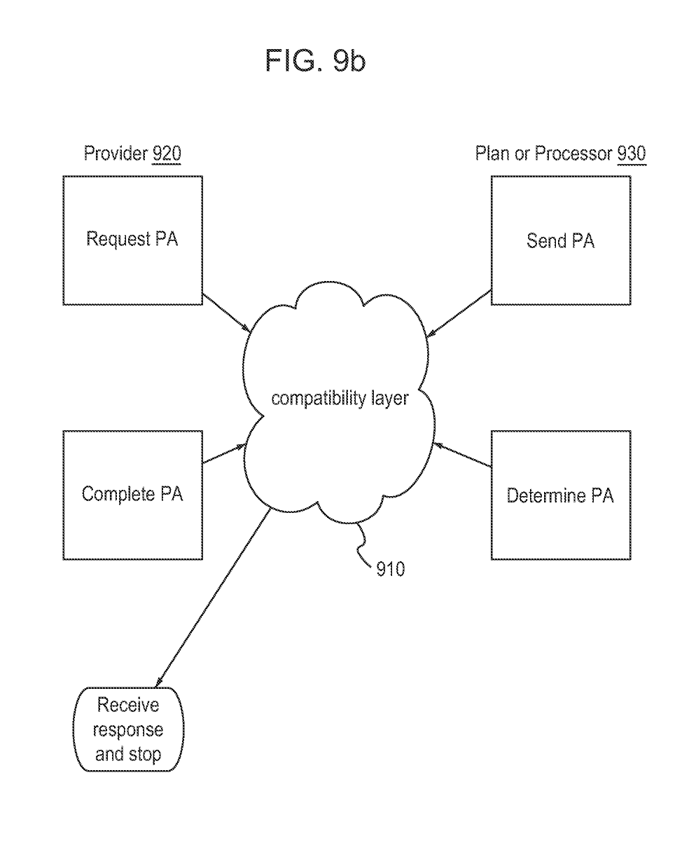

FIG. 9a shows a schematic of a request/response prior authorization workflow. This workflow may include, for example, a workflow implemented by the standardized NCPDP ePA transaction or an eligibility and benefits transaction, such as an ANSI 278 transaction. This diagram is shown to illustrate how certain embodiments of the invention, as shown in FIG. 9b, can supplement a process that requires point-to-point connectivity and imposes the burden of implementing and supporting these transactions on a large number of health plans and providers.

FIG. 9b shows a schematic for supplementing a request/response transaction to provide directory services and a visual or paper-based “compatibility layer” between parties that do not support the requested transaction type, in accordance with an embodiment of the invention. A compatibility layer 910 is provided between a provider 920 and a plan or processor 930. The compatibility layer 910 maintains a “directory” service to reduce the total connections from n² to 2(n−1). The compatibility layer 910 further encodes visual output definitions on top of standardized transaction formats so that the provider 920, who does not support an electronic transaction, can receive a visual output, for example, a facsimile, of the transaction, or vice versa. Because the visual output definition matches the plan's or processor's 930 original printed prior authorization document format, the compatibility layer 910 can support all plans, not just the plans that support an electronic transaction. Thus, the compatibility layer 910 provides forward and backward compatibility. For example, possible permutations of compatibility provided by the compatibility layer 910 include electronic-to-electronic transactions, paper-to-paper transactions, electronic-to-paper transactions, and paper-to-electronic transactions.

Some of the many advantages of embodiments of the invention include increasing the approval rate of prior authorizations, encouraging local networks of pharmacists and providers to form around patient access processes for increasing prior authorization form submission, helping drug manufacturers increase access to their drugs, and increasing patient preference at pharmacy by providing prior authorization assistance. Additional advantages of embodiments of the invention include increasing physician preference by improving patient access to drugs, increasing transparency of coverage criteria rules required to complete the prior authorization form, increasing call-center-based patient assistance by starting the process with a prior authorization system, and efficiently encoding prior authorization forms using a graphical tool and low-skilled labor. Furthermore, embodiments of the invention provide visual cues to increase user confidence in search results for generated prior authorization forms, allows a patient to start the prior authorization process for completion by his health care provider, use search engine optimization techniques to encourage prior authorization submissions. Certain embodiments of the invention allow users to make available on behalf of health plans, additional prior authorization forms that should be made available for use by all or some users, and to collect feedback on incorrect or outdated prior authorization forms using a feedback system.

The memory 210 may be of any type suitable to the local technical environment and may be implemented using any suitable data storage technology, machine or computer readable storage medium, such as semiconductor-based memory devices, flash memory, magnetic memory devices and systems, optical memory devices and systems, fixed memory and removable memory, as non-limiting examples. The processor 230 may be of any type suitable to the local technical environment, and may include one or more of general purpose computers, special purpose computers, microprocessors, digital signal processors (DSPs), and processors based on multi-core processor architecture, as non-limiting examples.

The computer program code 220 according to certain embodiments of the invention, may be composed of modules that are in operative communication with one another, and which are designed to pass information or instructions to an electronic device, such as a personal computer, a handheld device, such as a mobile, a cellular telephone, or a personal digital assistant (PDA) having wireless communication capabilities, a portable computer having wireless communication capabilities and a portable unit or a terminal that incorporates combinations of such functions, as non-limiting examples.

The embodiments of the invention discussed above may be implemented by hardware, computer software executable by the processor 230, or by a combination of hardware and software.

The software and/or hardware may reside on the processor 230 or other electronic devices. If desired, part of the software and/or hardware may reside on the processor 230, and part of the software and/or hardware on other electronic devices. In an embodiment of the invention, software, or an instruction set may be maintained on any one of various conventional computer-readable storage medium.

The steps of the methods, as shown in FIGS. 5-8, described in connection with the embodiments disclosed herein can be embodied directly in hardware, in the computer program code executed by the processor 230, or in a combination of the two. The computer program code 220, or product, can be embodied on a computer readable (i.e., non-transitory) storage medium. Non-transitory storage medium does not include a transitory signal. Examples of non-transitory storage medium may include, for example, a computer-readable medium, a computer distribution medium, a computer-readable storage medium, and a computer program. The computer readable storage medium may include any media or means that may contain, store, communicate, propagate or transport the instructions for use by or in connection with an instruction execution system, apparatus, or device, for example, a disk media, computer memory, or other storage device. For example, the computer program product 220 can reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art. The storage medium can be coupled to the processor 230 such that the processor 230 can read information from, and write information to, the storage medium. In the alternative, the storage medium can be integral to the processor 230. The processor 230 and the storage medium can reside in an application specific integrated circuit (ASIC). In the alternative, the processor 230 and the storage medium can reside as discrete components.

Thus, in accordance with an embodiment of the invention, there is provided a computer program product embodied on a non-transitory computer readable storage medium. The computer program product is encoded with instructions to control a processor to perform a process, which includes receiving a request to generate a prior authorization form for a prescription drug, and generating a prior authorization form from a plurality of prior authorization forms based on the request. The process further includes transmitting the generated prior authorization form to at least one of a pharmacy and a health care provider so that the at least one of the pharmacy and the health care provider can modify the prior authorization form.

One having ordinary skill in the art will readily understand that the invention as discussed above may be practiced with steps in a different order, and/or with hardware elements in configurations which are different than those which are disclosed. Therefore, although the invention has been described based upon these preferred and non-limiting embodiments, it would be apparent to those of skill in the art that certain modifications, variations, and alternative constructions would be apparent, while remaining in the spirit and scope of the invention. Thus, the example embodiments do not limit the invention to the particular listed devices and technologies. In order to determine the metes and bounds of the invention, therefore, reference should be made to the appended claims.

We claim:

1. An apparatus, comprising:
at least one memory including computer program code; and
at least one processor,
wherein the at least one memory and the computer program code are configured to, with the at least one processor, cause the apparatus at least to
receive a request to generate a prior authorization form for a prescription drug,
select the prior authorization form from a plurality of prior authorization forms based on the request, wherein the prior authorization form is selected based on at least one of a user search result and a standardized transaction, and
transmit the selected prior authorization form to a user so that the user can complete the selected prior authorization form.

2. The apparatus of claim 1, wherein the at least one memory and the computer program code are further configured to, with the at least one processor, cause the apparatus at least to transmit, upon receiving a completed prior authorization form from the user, the completed prior authorization form to a health insurance provider, wherein the health insurance provider evaluates the completed prior authorization form to determine whether to approve, deny, cancel, or request additional information for the prior authorization form.

3. The apparatus of claim 1, wherein the user comprises at least one of a pharmacy, a health care provider, and a patient.

4. The apparatus of claim 1, wherein the at least one memory and the computer program code are further configured to, with the at least one processor, cause the apparatus at least to
generate the prior authorization form, based on the request, when the prior authorization form is not found in the plurality of prior authorization forms, and
transmit the generated prior authorization form to the user so that the user can complete the generated prior authorization form.

5. The apparatus of claim 1, wherein the at least one memory and the computer program code are further configured to, with the at least one processor, cause the apparatus at least to grant access to the user so that the user can complete the selected prior authorization form.

6. The apparatus of claim 1, further comprising:
a graphical user interface configured to provide the user with access to the selected prior authorization form.

7. The apparatus of claim 1, wherein the at least one memory and the computer program code are further configured to, with the at least one processor, cause the apparatus at least to complete the prior authorization form in real-time using at least one of a user input, the user search result, and the standardized transaction.

8. The apparatus of claim 4, wherein the at least one memory and the computer program code are further configured to, with the at least one processor, cause the apparatus at least to interoperate with at least one of a health care data standard and an arbitrary and non-standard format for generating the prior authorization form.

9. The apparatus of claim 1, wherein the at least one memory and the computer program code are further configured to, with the at least one processor, cause the apparatus at least to receive the request to generate the prior authorization form for the prescription drug, wherein the request comprises at least one of a patient's health insurance provider and the prescription drug for which the request is being made for prior authorization.

10. The apparatus of claim 1, wherein the at least one memory and the computer program code are further configured to, with the at least one processor, cause the apparatus at least to select the prior authorization form based on the standardized transaction comprising at least one of a pharmacy claim, an electronic prescription, and a patient clinical document.

11. A method for processing a prior authorization for a prescription drug, the method comprising:
receiving a request to generate a prior authorization form for a prescription drug;
selecting the prior authorization form from a plurality of prior authorization forms based on the request, wherein the prior authorization form is selected based on at least one of a user search result and a standardized transaction; and
transmitting the selected prior authorization form to a user so that the user can complete the prior authorization form.

12. The method of claim 11, further comprising:
upon receiving a completed prior authorization form from the user, transmitting the completed prior authorization form to a health insurance provider, wherein the health insurance provider evaluates the completed prior authorization form to determine whether to approve, deny, cancel, or request additional information for the prior authorization form.

13. The method of claim 11, wherein the transmitting comprises transmitted the selected prior authorization form to the user comprising at least one of a pharmacy, a health care provider, and a patient.

14. The method of claim 11, further comprising:
generating the prior authorization form, based on the request, when the prior authorization form is not found in the plurality of prior authorization forms, and
transmitting the generated prior authorization form to the user so that the user can modify the generated prior authorization form.

15. The method of claim 11, further comprising:
granting access to the user so that the user can complete the selected prior authorization form; and
providing the user with access to the selected prior authorization form.

16. The method of claim 11, further comprising:
completing the prior authorization form in real-time using at least one of a user input, the user search result, and the standardized transaction; and
generating the prior authorization form using at least one of a health care data standard, and an arbitrary and non-standard format.

17. The method of claim 11, wherein the receiving comprises receiving the request to generate the prior authorization form for the prescription drug, wherein the request comprises at least one of a patient's health insurance provider and the prescription drug for which the request is being made for prior authorization.

18. The method of claim 11, wherein the selecting the prior authorization form is based on the standardized transaction comprising at least one of a pharmacy claim, an electronic prescription, and a patient clinical document.

19. A computer program product embodied on a non-transitory computer readable storage medium, the computer program product being encoded with instructions to control a processor to perform a process, the process comprising:
receiving a request to generate a prior authorization form for a prescription drug;
selecting the prior authorization form from a plurality of prior authorization forms based on the request, wherein the prior authorization form is selected based on at least one of a user search result and a standardized transaction; and
transmitting the selected prior authorization form to a user so that the user can complete the prior authorization form.

20. The computer program product of claim 19, wherein the process further comprises, upon receiving a completed prior authorization form from the user, transmitting the completed prior authorization form to a health insurance provider, wherein the health insurance provider evaluates the completed prior authorization form to determine whether to approve, deny, cancel, or request additional information for the prior authorization form.
